(19) United States
(12) Patent Application Publication
(10) Pub. No.: US 2017/0142010 A1
(43) Pub. Date: May 18, 2017

(54) NETWORK OPERATION RULE

(71) Applicant: HEWLETT PACKARD ENTERPRISE DEVELOPMENT LP, Houston, TX (US)

(72) Inventors: Subin Mathew, Bangalore (IN); Sugesh Chandran, Bangalore (IN)

(21) Appl. No.: 15/127,445

(22) PCT Filed: May 30, 2014
(86) PCT No.: PCT/US2014/040331

§ 371 Date: Sep. 20, 2016

(30) Foreign Application Priority Data
Mar. 20, 2014 (IN) 1499/CHE/2014

(51) Int. Cl. H04L 12/741; H04L 12/24

(52) U.S. Cl. CPC H04L 45/745; H04L 41/20

(57) ABSTRACT

A software defined networking policy may be generated corresponding to an operation of a network device. A match field may be obtained and provided to the network device. A rule corresponding to the operation may be received from the network device. The rule may be used to generate the software defined networking policy.

### BACKGROUND

In networks using software defined networking (SDN), one or more network controllers may manage the control plane of network devices, such as switches, bridges and routers. The network controller may also manage the data plane of the switches by providing flow rules to the switches. The flow rules may have various attributes, such as match fields, meters, go-to instructions, and actions. The match fields of a flow rule establish a corresponding flow by setting commonalities shared by packets of the flow. During operation, if a match field is met by a packet then the network device performs the action on the packet. Accordingly, the match field establishes the action performed by device on the flow. Match fields may include various criteria, such as source or destination IP or MAC address, port numbers, transport protocol type, frame type, class of service indicators, or frame control information. Actions may include various operations that the switch can perform on packets, such as forwarding the packet to a specified port, dropping the packet, or forwarding the packet to the controller.

### BRIEF DESCRIPTION OF THE DRAWINGS

Certain examples are described in the following detailed description and in reference to the drawings, in which:

FIG. 1 illustrates an example method of using a rule received from a network device to generate an SDN policy corresponding to the rule;

FIG. 2 illustrates an example method of collecting rules from a plurality of network devices and using the rules to generate an SDN policy;

FIG. 3 illustrates an example network device having a non-transitory computer readable medium storing instructions to transmit a rule for a legacy network operation to a network controller;

FIG. 4 illustrates an example network device executing an SDN agent and a legacy rule reporting agent; and

FIG. 5 illustrates an example controller including a rule collector, policy analyzer, and flow programmer.

### DETAILED DESCRIPTION OF SPECIFIC EXAMPLES

Network devices may perform various operations on received packets. For example, network operations may include switching, bridging, routing, filtering, access control list (ACL) processing, quality-of-service (QoS) processing, packet header field rewriting, packet inspection, or data collection. These network operations may be implemented as SDN operations using flow rules, or as non-SDN legacy operations. These legacy operations may be implemented using various agents executed on the network devices in non-standard or platform specific ways using platform specific rules. As examples, the legacy operation may be layer 2 Ethernet switching, virtual local area network (VLAN) isolation, layer 3 routing such as IPv4 or IPv6 routing, access control list (ACL) processing, filtering, or quality-of-service (QoS) processing.

Some network devices, such as switches like bridges and routers, may capable of operating in a hybrid manner supporting both SDN operation and legacy operations. A hybrid network device may perform a legacy operation in a network slice implemented without SDN. The network slice may be defined by any network parameters that isolate packets on the network slice from other packets on the network. For example, a network slice may be defined by a topology of connected network devices, a set of ports, a VLAN, a set of addresses, or by one or more match fields supported by an SDN flow rule. In some cases, the network slice may be the entire network.

In some cases, when transitioning a network slice to SDN-controlled operation is performed in a reactive manner. In a reactive transition, a default flow rule is programmed in the network devices' flow tables to send all packets of the slice to a network controller. For example, in an OPENFLOW SDN, the OPENFLOW switches are programmed with a PKT_IN command for packets having match fields corresponding to the network slice. After receiving a forwarded packet, the controller determines a policy for how the packet and other packets of the same flow should be treated. The controller then programs a more specific flow rule in all appropriate network devices to implement the policy. Large numbers of incoming flows may overwhelm the controller. Accordingly, the transition may be forced to proceed slower than desired to overwhelm the network controller. Additionally, each unknown flow will incur latency equal to the roundtrip delay to the controller plus the policy resolution delay at the network controller. This delay may negatively impact network performance and may cause packet drops caused by buffer overload at the controller.

Aspects of the disclosed technology may allow transition a network slice to SDN in a proactive manner. A network controller may obtain rules from the network devices under its control that reflect current operations, such as existing legacy network operations. These rules may be used by the controller to generate policies that implement the existing network operations. These policies may be implemented by SDN flow rules provided to the network devices. Accordingly, after proactively programming the network devices of a slice, the transition to SDN may occur with fewer unknown flows being forwarded to the network controller.

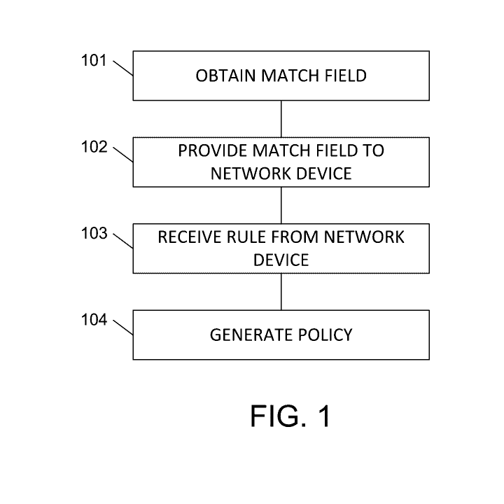

FIG. 1 illustrates an example method of using a rule received from a network device to generate an SDN policy corresponding to the rule. For example, the method may be performed by an SDN network controller, such as an OPENFLOW controller, to proactively program controlled network devices during transition from legacy operations to SDN controlled operations. The network device may be a hybrid network device capable of legacy operations as well as SDN operations.

The example method may include block 101. Block 101 may include obtaining a match field. For example, the match field may be one of a set of match fields available for flow rules in an SDN protocol. For example, the match field may be an input port field, an Ethernet destination or source address field, an Ethernet frame type, a VLAN identification (ID) or priority field, or an IP source or target address. In further implementations, block 101 may include obtaining one or more match fields. In some cases, the match fields may be obtained from a network administrator. For example, the match fields may define a network slice selected by an administrator to be transitioned to an SDN.

In some implementations, block 101 may include obtaining a set of match fields with associated values or bitmasks. For example, block 101 may include obtaining a set of port numbers for connected network devices or a specific VLAN ID. In other implementations, block 101 may include obtaining a set of match fields without associated values. For example, the set of match fields may define a type of network slice and may correspond to a plurality of network slices of that type.

The example method may further include block 102. Block 102 may include providing the match field to a network device. In some cases, block 102 may include providing the match field over an SDN management connection to an SDN agent executed by the network device. For example, block 102 may include providing the match field to an OPENFLOW agent executed at the control plane of an OPENFLOW switch. In other cases, block 102 may include providing the match field to legacy operations executed by the network device. For example, the match field may be provided by requesting a report for information corresponding to the match field.

In some implementations, block 102 may include providing an identification of legacy applications that the network device should query for operations related to the match fields. For example, a network administrator may be transitioning an ACL to an SDN implementation. The ACL operations on the network may involve fields overlapping with other legacy operations, such as routing operations. The identification of legacy applications may limit information received back from the network device to information pertinent to the network transition. For example, the identification of legacy applications may be included in the report request.

The example method may further include block 103. Block 103 may include receiving a rule from the network device. The rule may correspond to an operation of the network device related to the match field. The operation may be an existing operation performed in a non-SDN manner that is based on the same parameters as reflected in the match field. For example, depending on match fields providing in block 102, the operation may be a routing decision, an ACL/QoS decision, a layer 2 forwarding decision, or a filtering rule such as a multicast filtering rule. In some implementations, the rule received in block 103 may be a flow rule formatted in accordance with an SDN protocol. In these implementations, the network device may generate a flow rule that reflects the existing operation. For example, if the existing operation is a layer 2 forwarding decision to forward packets from MAC address X to MAC address Y on port Z, the rule received in block 103 may be a flow rule with source and destination MAC address match fields set to X and Y, and a forwarding action set to port Z. Receiving the rule in block 103 as a flow rule may allow rules received from different platforms to be compared in a normalized manner.

The method may further include block 104. Block 104 may include using the rule to generate an SDN policy corresponding to the operation. The SDN policy may be a set of flow rules that implement the operation in an SDN-compliant manner. For example, if the rule received in block 103 is a QoS rule setting the priority of packets matching certain source, destination, and type information, the SDN policy may be a flow rule having the corresponding source, destination, and type match fields and an action that reflects the priority. In some cases, block 104 may include providing the SDN policy to a network administrator. For example, the policy may be provided as an option for programming an SDN network to maintain existing behavior.

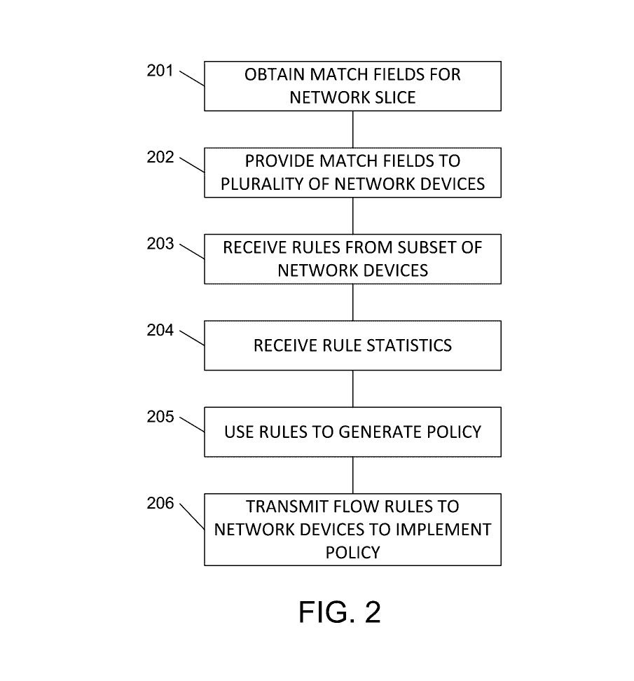

FIG. 2 illustrates an example method of collecting rules from a plurality of network devices and using the rules to generate an SDN policy. For example, the method of FIG. 2 may be performed as an implementation of the method of FIG. 1.

The example method may include block 201. Block 201 may include obtaining a set of match fields corresponding to a network slice. Block 201 may also include obtaining an identification of legacy applications or operations that correspond to the network slice. For example, the match fields and legacy application or operation identification may be provided by a network administrator as part of transitioning a legacy network slice into SDN operation.

The example method may further include block 202. Block 202 may include providing the set of match fields to a plurality of network devices. In some cases, block 202 may be an implementation of block 101 of FIG. 1. For example, block 202 may broadcasting the match fields to all network devices connected to a network controller implementing the method. As another example, block 202 may include individually sending or multicasting a request including the match fields to network devices in the network slice.

The example method may also include block 203. Block 203 may include receiving a plurality of rules from a subset of the plurality of network devices. For example, the subset may be all network devices having a legacy operation corresponding to the set of match fields. In some case, the subset may be the entire plurality of network devices. Each rule may correspond to an operation of a network device of the subset and may be related to the match field or fields sent in block 201. For example, block 203 may be an implementation of block 103 of FIG. 1.

The example method may also include block 204. Block 204 may include receiving a statistic related to the operation. In some cases, the statistic may be a count of how many times the operation has been performed in an interval. For example, the statistic may be a hit count of how many times the operation is performed in a day or an indication of when the operation was last performed. In some cases, block 204 may include receiving statistics for the corresponding rules from each of network device of the subset of network devices.

The example method may also include block 205. Block 205 may include using the rules obtained in block 203 to generate an SDN policy. For example, block 205 may be an implementation of block 104 of FIG. 1. In some cases, the rules may be used to identify flows that can be proactively programmed. For example, flows that can be proactively preprogrammed may be any flow that can be implemented using the SDN protocol of the network. As another example, flows that can be proactively programmed may correspond to obtained rules that traverse the network slice.

In some implementations, SDN policies may be determined based on the received rules in a prioritized manner. In some cases, the statistics may be used to identify which flows to proactively preprogram. For example, the SDN policy may be generated if the statistic or statistics for the operation exceeds a threshold. In a further example, an administrator may define which rules have higher priorities for determining SDN policies. For example, SDN policies may be for rules having higher hit counts than other rule, for rules that correspond to more recent operations, or for rules that are identified as high priority by the administrator.

In some implementations, the SDN policy corresponding to the operation may replicate the network behavior created by the operation. For example, block 205 may include identifying an existing network path within the network slice from a subset of the received rules. Block 205 may include generating an SDN policy as a set of flow rules to implement the existing network path. As another example, block 205 may include identifying a network device that performs ACL or QoS operations. The SDN policy may be a rule for the same network device so that it continues to perform the ACL or QoS operations after being programmed with the rule.

In other implementations, the SDN policy corresponding to the operation may change the behavior of the network. For example, block 205 may include generating an SDN policy as a set of flow rules to implement a new network path derived from the existing network path. In some cases, the new network path may take into consideration overriding requirements provided by a network administrator or the new network path may be generated using the existing path as a cost parameter in a routing application. As another example, block 205 may include identifying a new network device to perform ACL or QoS operations. In some cases, the controller may determine that multiple network devices are performing ACL or QoS operations redundantly, and the policy may eliminate such redundancy. In other cases, an administrator may identify a different network device that is responsible for ACL or QoS, and the controller may determine a network policy as a rule for the different network device that replicates the ACL or QoS behavior of the previous network device.

The method may also include block 206. Block 206 may include transmitting flow rules to network devices to implement the SDN policy. As described above, implementing the SDN policy may involve the same network devices performing the existing operations, or may involve different network devices. Accordingly, block 206 may include transmitting the flow rules to the same network devices providing the rules in block 203. Block 206 may also include transmitting the flow rules to different network devices than the ones providing the rules in block 203.

In some implementations, the flow rules are transmitted to the network devices prior to SDN operations. Accordingly, after a transition to SDN-controlled operations, only flows that do not match the proactively instantiated flows will arrive at the controller. This may prevent the controller from being overloaded, reduce network congestion, and reduce the load on the network devices to send packets to the controller.

In other implementations, the flow rules are transmitted during SDN operations after the controller receives a packet matching the flow rule from a network device. For example, during transition to SDN, blocks 201-205 may be performed to proactively determine flow rules to implement the existing network behavior. However, those flow rules may only be provided to network devices when needed. This may reduce latency and reduce the computational load on the network controller.

In still further implementations, some flow rules are transmitted prior to SDN operation and some flow rules are provided on an as-needed basis. In some cases, statistics used received in block 204 are used to determine whether to transmit a flow rule to implement the SDN policy. For example, flow rules may be sent to the devise if the hit count for the corresponding operation exceeds a certain threshold. For example, flow table size limitations may prevent flow rules from being sent to implement SDN policies for all existing operations. The threshold may be set according to the flow table size limitations. For example, the threshold may be a percentage of the number of table entries, with some entries reserved for new operations.

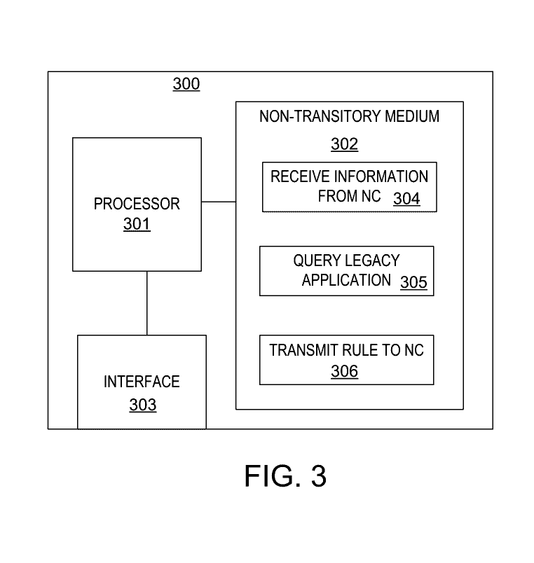

FIG. 3 illustrates an example network device 300 having a non-transitory computer readable medium 302 storing instructions to transmit a rule for a legacy network operation to a network controller. In some implementations, the network device 300 may be a hybrid device capable of performing legacy operations and SDN operations. For example, the legacy operations may include a routing decision, an ACL/QoS decision, a layer 2 forwarding decision, or a filtering rule such as a multicast filtering rule. The SDN operations may include executing flow rules complying with an SDN protocol. For example, the network device 300 may be capable of operating as an OPENFLOW switch.

The example network device 300 may include a processor 301. The processor 301 may execute various control plane applications. For example, the control plane applications may include SDN applications including an SDN agent, such as an OPENFLOW agent, and a legacy flow reporting agent. The control plane applications may also include legacy applications, such as route managers, L2 address managers, ACL managers, QoS managers, or other non-SDN function-related applications. These applications may be stored as software instructions on a non-transitory computer readable medium, such as random access memory (RAM), read only memory (ROM), flash memory, or storage. The network device 300 may also include a network interface 303. The network interface 303 may be used by the processor 301 to communicate with a network controller over an SDN management channel, such as an OPENFLOW channel.

The medium 302 may store instructions 304 executable by the processor 301 to receive a match field from a network coordinator. In some implementations, the instructions 304 may be executable to receive a set of match fields from the network coordinator. For example, the match fields may define a network slice to be transitioned from legacy operation to SDN operation. In some implementations, the instructions 304 may be executable to receive an identification of which legacy application to query for legacy operations. For example, the match field and legacy application identification may be received in an information request packet sent by the network controller.

The medium 302 may store instructions 305 executable by the processor 301 to query a legacy application to obtain a legacy network operation related to the received match field. For example, the instructions 305 may be executed as part of execution of a legacy rule reporting agent and the legacy application may be executed on the processor 301 as well. The processor 301 may query the legacy application using inter-application communications. In some implementations, the legacy application queried may be an application identified in the transmission received in FIG. 3. In further implementations, the instructions 305 may be executable to determine which legacy applications on the network device 300 may include rules applicable to the match field.

The instructions 305 may be executable by the processor 301 to obtain identification of legacy network operations related to the match field from the legacy applications. For example, the legacy network operations may be obtained as legacy rules, such as routing rules, bridging rules, ACL rules, or QoS rules. The instructions 305 may be further executable to obtain statistics related to the legacy network operations, such as hit counts or timestamps of last execution of the operations.

The medium 302 may store further instructions 306 executable by the processor 301 to transmit a rule for the legacy network operation to the network controller. In some cases, the transmitted rule is a flow rule, and the instructions 306 are executable to convert a legacy rule for the network operation into a flow rule. Instructions 306 may be further executable to transmit any statistics collected from the legacy applications to the network controller.

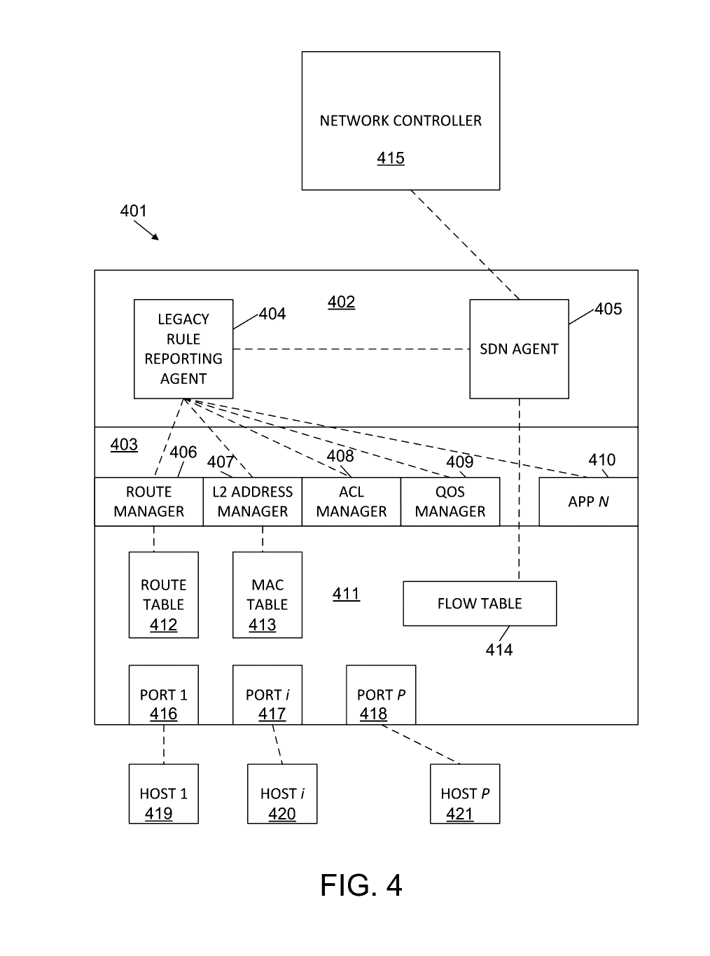

FIG. 4 illustrates an example network device 401 executing an SDN agent 405 and a legacy rule reporting agent 404. For example, the network device 401 may be an implementation of the network device 300 of FIG. 3.

The example network device 401 may be capable of hybrid network operations, including legacy, non-SDN, network operations and SDN operations. Accordingly, the device 401 may include an SDN control plane 402 and a legacy control plane 403. In some implementations, the control planes 402, 403 may be executed as hardware functions, software applications stored on a non-transitory computer readable medium and executed by a processor, or combinations thereof. The device 401 may further include hardware resources 411 and ports 416-418. For example, the hardware resources 411 may include control application specific integrated circuits (ASICs), field-programmable gate arrays (FPGAs), ternary content addressable memory (TCAM), or other hardware. Applications executed on the control planes 402, 403 may control how packets received from hosts 419-421 on the ports 416-418 are treated by the device. The hosts 419-421 may be end devices or other network devices.

The SDN control plane 402 may include an SDN agent 405. The SDN agent 405 may connect to a network controller 415 over a management channel. For example, the SDN agent 405 may receive flow rules from the controller 415 and program those flow rules into a flow table 414. In some cases, a flow table 414 may be implemented using hardware resources 411. In some cases, a flow table 414 may be implemented in software as instructions executed by a processor and stored on a computer readable medium. In still further cases, the a network device 401 may include a flow pipeline including flow tables implemented in software and flow tables implemented in hardware.

The SDN control plane 402 may further include a legacy rule reporting agent 404. Execution of the legacy rule reporting agent 404 may involve execution of the instructions 304-306 of FIG. 3. For example, the controller 415 may inform the reporting agent 404 on the network device 402, and any other devices 402 in the network, about an impending network slice and match fields defining the slice. The agent 404 may query legacy applications 406-410 on the legacy control plane 402 to provide rules that they have configured that are related to the parameters on which the network slicing will be done. For example, the legacy applications 410 may include a route manager 406 managing routes on a routing table 412, a layer 2 address manager 407 managing a MAC table 413, an ACL manager 408, a QoS manager 409, or other legacy application 410. When receiving a query, the legacy applications 406-410 may search their respective hardware or software agents and reply to the agent 404 with platform specific rules that they have programmed. The legacy applications 406-410 may further respond with rule priorities or statistics, if available. The agent 404 may convert the platform specific rules into SDN protocol-compliant flow rules and provide them to the network controller 415 via the SDN agent 405.

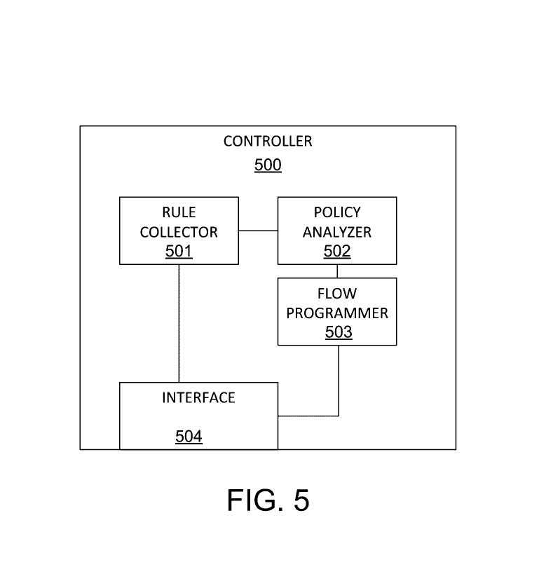

FIG. 5 illustrates an example controller 500 including a rule collector 501, policy analyzer 502, and flow programmer 503. For example, the controller 500 may be an SDN network controller able to connect to a network device, such as a network device 401 of FIG. 4, and perform a method of generating an SDN policy, such as the method of FIG. 1 or 2. In some implementations, the module 501, 502, 503 may be implemented as instructions stored on a non-transitory computer readable medium and executable by a processor.

The controller 500 may include a rule collector 501. The rule collector 501 may be configured to collect a rule for a legacy network operation corresponding to a match field from a first network device. In some cases, the legacy network operation may be an access control operation, a quality of service operation, a forwarding operation, a filtering operation, or a multicast operation. For example, the rule collector 501 may be able to query legacy rule reporting agents executed by network devices using a network interface 504. For example, the rule collector 501 may be able to perform block 101-103 of FIG. 1.

In some cases, the rule collector 501 may collect a plurality of legacy rules corresponding to the match field from a corresponding plurality of network devices. The rule collector 501 may transmit a set of match fields corresponding to a network slice to a plurality of network devices and collect a set of rules from the plurality of network devices. For example, the rule collector 501 may perform blocks 201-203 of FIG. 2.

Additionally, the rule collector 501 may collect statistics related to legacy rules from network devices. For example, the rule collector 501 may collect a hit count for the legacy rule from a network device. The rule collector 501 may collect such statistics as described with respect to block 204 of FIG. 2.

The controller 500 may also include a policy analyzer 502. In some implementations, the policy analyzer 502 may perform block 104 of FIG. 1 or block 205 of FIG. 2. The policy analyzer may use the rule or rules provided by the rule collector 501 to determine a policy for packets matching the match field. For example, the policy analyzer 502 may collate all rules received by the rule collector 501, and determine a final set of SDN rules that can be programmed onto a set of network devices. In some cases, the policy analyzer 502 may obtain an overriding requirement and determine the policy to meet the overriding requirement. The final set of SDN rules may implement a network behavior resulting from the legacy rules. For example, the policy may mimic the operation of the network under the legacy rules consistent with any overriding requirements.

The policy analyzer 502 may determine the policy from a subset of the rules meeting a rule priority requirement. In some cases, the policy analyzer 502 may receive a rule priority requirement from a network administrator. For the rule priority requirement may instruct the analyzer 502 to determine SDN rules based on which collected rules have a higher hit count, the most recently hit rules, or any other configured priority.

The controller 500 may also include a flow programmer 503. In some implementations, the flow programmer 503 may be configured to perform block 206 of FIG. 2. The flow programmer may transmit a flow rule to implement the policy determined by the policy analyzer 502. For example, the flow programmer may transmit flow rules to all or a subset of network devices connected to the controller 500 via an interface 504. In some cases, the flow programmer 503 may use statistics related to the legacy rules to determine whether to transmit a flow rule to a network device. For example, the flow programmer 503 may transmit a flow rule to a network device if the hit count for a corresponding legacy rule meets a threshold condition.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A method, comprising:
obtaining a match field;
providing the match field to a network device;
receiving a rule from the network device, the rule corresponding to an operation of the network device related to the match field;
using the rule to generate a software defined networking (SDN) policy corresponding to the operation.

2. The method of claim 1, further comprising:
providing the match field to a plurality of network devices, the network device being one of the plurality;
receiving a plurality of rules from a subset of the plurality of network devices, each rule corresponding to a corresponding operation of a corresponding network device of the subset that is related to the match field; and
using the plurality of rules to generate the SDN policy.

3. The method of claim 1, further comprising:
generating a plurality of flow rules to implement the SDN policy; and
transmitting the plurality of flow rules to a plurality of network devices in a network, the network including the plurality of network devices.

4. The method of claim 1, further comprising:
receiving a statistic related to the operation; and
using the statistic to determine whether to transmit a flow rule to implement the SDN policy.

5. A non-transitory computer readable medium storing instructions executable by a processor to:
receive a match field from a network controller;
query a legacy application to obtain a legacy network operation related to the match field; and
transmit a rule for the legacy network operation to the network controller.

6. The non-transitory computer readable medium of claim 5, storing further instructions executable by the processor to:
receive an identification of the legacy application from the network controller.

7. The non-transitory computer readable medium of claim 5, wherein the rule is a software defined networking rule and the legacy network operation is obtained as a legacy rule, and storing further instructions executable by the processor to:
convert the legacy rule into the software defined networking rule.

8. The non-transitory computer readable medium of claim 5, storing further instructions executable by the processor to:
query the legacy application to obtain a statistic related to the legacy network operation; and
transmit the statistic to the network controller.

9. A controller, comprising:
a rule collector to collect a rule for a legacy network operation corresponding to a match field from a network device;
a policy analyzer to use the rule to determine a policy for packets matching the match field; and
a flow programmer to transmit a flow rule to implement the policy.

10. The controller of claim 9, wherein the rule collector is to collect a plurality of legacy rules corresponding to the match field from a corresponding plurality of network devices, the network device being one of the plurality.

11. The controller of claim 10, wherein the policy analyzer is to obtain an overriding requirement and to determine the policy to meet the overriding requirement and to implement a network behavior resulting from the legacy rules.

12. The controller of claim 9, wherein:
the rule collector is to collect a hit count for the legacy rule from the network device.

13. The controller of claim 12, wherein:
the flow programmer is to transmit the flow rule to the network device if the hit count meets a threshold condition.

14. The controller of claim 9, wherein:
the rule collector is to transmit a set of match fields corresponding to a network slice to a plurality of network devices, the first network device being one of the plurality and the match field being one of the set of match fields;
the rule collector is to collect a set of rules from the plurality of network devices; and
the policy analyzer is to determine the policy from a subset of the rules meeting a rule priority requirement.

15. The controller of claim 9, wherein:
the legacy network operation is an access control operation, a quality of service operation, a forwarding operation, a filtering operation, or a multicast operation.
